(19) United States
(12) Patent Application Publication
(10) Pub. No.: US 2004/0222886 A1
(43) Pub. Date: Nov. 11, 2004

(54) Device for and method of locating remote control for apparatuses

(76) Inventor: Vladislay A. Davankov, Moscow (RU)

Correspondence Address: Ilya Zborovsky, 6 Schoolhouse Way, Dix Hills, NY, 11746, US

(21) Appl. No.: 10/430,077

(22) Filed: May 6, 2003

(51) Int. Cl. G08B 1/08

(52) U.S. Cl. 340/539.32

(57) ABSTRACT

For locating a remote control operative for controlling an operation of an apparatus, an apparatus turning element is activated by a user, and simultaneously a signal generating element is activated to send a signal to the remote control so that the remote control produces a user recognizable signal.

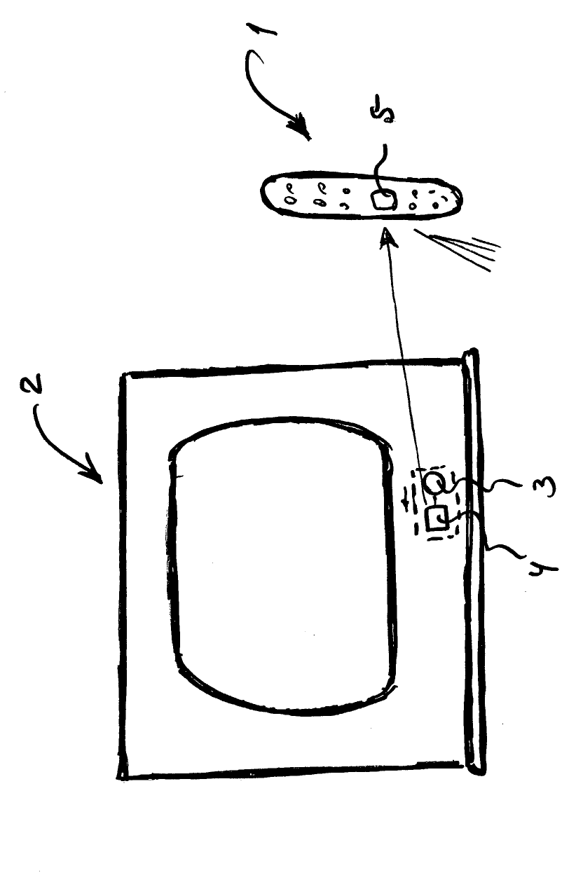

### BACKGROUND OF THE INVENTION

The present invention relates to a device for and method of locating remote controls for apparatuses.

Remote controls are widely utilized for remotely controlling corresponding apparatuses, for example television sets, radios, household devices, etc. Devices and methods for locating remote controls are known in accordance with which corresponding signals are produced by a user, for example whistling, clapping of hands, etc., and the remote control generates a signal recognizable by a user, for example an audible signal and/or a visual signal. It is believed that the existing devices and methods can be further improved.

### SUMMARY OF THE INVENTION

Accordingly, it is an object of the present invention to provide a device for and a method of locating a remote control, which is a further improvement of the existing devices and methods.

In keeping with these objects and with others which will become apparent hereinafter, one feature of the present invention resides, briefly stated, in a device for locating a remote control which includes means for turning an apparatus; means for activating a signal produced by a remote control, said turning means and said turning means being formed so that when said activating means is activated by a user, said turning means provide turning of the apparatus and said activating means activate a signal produced by the remote control.

It is another feature of the present invention to provide a method in accordance with which for locating a remote control which includes means for turning an apparatus and means for activating a signal produced by a remote control are formed so that when said turning means is activated by a user, said turning means provide turning of the apparatus and said activating means activate a signal produced by the remote control.

When the device is formed and a method is performed in accordance with the present invention, they constitute a further improvement of the existing devices and methods.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings is a view schematically illustrating a device for locating remote control which carries out a method for locating of the remote control in accordance with the present invention.

### DESCRIPTION OF THE PREFERRED EMBODIMENTS

In accordance with the present invention, a device for locating a remote control is proposed, with the remote control identified as a whole with reference numeral 1. It controls operation of an apparatus which is identified as a whole with reference numeral 2.

The apparatus 2, for example a television set, has means 3 for turning the apparatus, for example for turning the television set on or off. In accordance with the present invention, means is provided for activating a signal to be produced by the remote control. Such means is identified with reference numeral 4. The remote control 1 has a receiving element 5 which can produce a signal itself or can be connected with signal generating means.

When the activating means 4 is activated by a user, for example a turning button of the activating means 4 is pressed by the user, the signal is transmitted to the receiver 5 for example by infrared radiation, etc., and the receiver 5 itself or a generating element connected with the receiver 5 produces a corresponding signal, for example a sound signal, a light signal, etc., so that a user can locate the remote control 1.

In accordance with the present invention, the turning means 3 of the apparatus 2 is operatively connected with the activating means 4 so that when the turning means 3 is activated by a user to turn the apparatus 2, the activating means 4 produce a signal which is sent to the receiver 5 of the remote control 1. For example, if a user activates the turning means 3 so as to turn on the apparatus formed as the television set 2, the turning means 3 (for example a power button) sends a signal to the activating means 4, and the activating means 4 sends a signal to the receiver 5. Thus, the operation of turning of the apparatus 2 is combined with the operation of activating of the activating means (for example the button 4).

In accordance with another embodiment of the present invention, the elements 3 and 4 can be integrated so that actually there is just one element. In other words, there is only one button (as shown in dotted line) which simultaneously turns the apparatus 2 (on or off), and simultaneously a signal is generated which is supplied to the receiver 5 so as a signal is generated in the remote control 1, recognizable by a user.

It will be understood that each of the elements described above, or two or more together, may also find a useful application in other types of constructions differing from the types described above.

While the invention has been illustrated and described as embodied in a device for and method of locating remote control for apparatuses, it is not intended to be limited to the details shown, since various modifications and structural changes may be made without departing in anyway from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A device for locating a remote control operative for controlling an operation of an apparatus, the device comprising means for turning the apparatus, means activatable by a user and activating in a remote control a signal which is recognizable by a user, said turning means and said activating means being in operative connection so that when said turning means is activated by a user, said activating means is simultaneously activated to send a signal to the remote control in which in turn the signal recognizable by a user is produced.

2. A device as defined in claim 1, wherein said turning means for turning the apparatus is operatively connected with said activating means which is formed as means separate from said turning means.

3. A device as defined in claim 1, wherein said means for turning the apparatus and said means for activating a signal in the remote control is formed as a joint means operating simultaneously.

5. A method for locating a remote control operative for controlling an operation of an apparatus, comprising the steps of providing means for turning the apparatus, and means activatable by a user and activating in a remote control a signal which is recognizable by a user; and operative connecting said turning means and said activating means so that when said turning means is activated by a user, said activating means is simultaneously activated to send a signal to the remote control in which in turn the signal recognizable by a user is produced.

6. A method as defined in claim 5; and further comprising forming said activating means which is formed as means separate from said turning means.

7. A method as defined in claim 5; and further comprising integrating said turning means with said activating means so that said means for turning the apparatus and said means for activating a signal in the remote control is formed as a joint means operating simultaneously.
